(19) United States
(12) Patent Application Publication
(10) Pub. No.: US 2009/0257254 A1
(43) Pub. Date: Oct. 15, 2009

(54) VOLTAGE-CLAMP POWER CONVERTERS

(75) Inventor: Ching-Shan Leu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei City (TW)

(21) Appl. No.: 12/102,877

(22) Filed: Apr. 15, 2008

(51) Int. Cl. H02M 7/217

(52) U.S. Cl. 363/40

(57) ABSTRACT

Several inversion circuits used to convert a DC input to an AC output comprise two series circuits, at least one clamp capacitor, and at least one transformer. Each of the series circuits is in parallel with the DC input. The first series circuit includes one switch network and at least one transformer primary. The second series circuit includes one voltage-clamp network and at least one transformer primary. At least one clamp capacitor couples the first and the second series circuits, and is attached to each series circuit at a node between the respective transformer primary winding. The voltage-clamp network may be implemented with two of the three sub-circuits connected in series: a diode, a resister-capacitor-diode, and a MOSFET-capacitor.

### BACKGROUND OF THE INVENTION

1. Field of Invention

The present invention is related to the field of power converter, and more specifically, to a voltage-clamp method for DC/DC power converters.

2. Description of Related Art

Achieving a higher power density is an endless goal of modern power converter engineers for the crucial applications wherein the allocated space of the power converter is limited. In addition to being highly compact, the power converter has to be able to minimize the power dissipation.

In low-to-medium level power conversion applications, single-ended power converter topology, such as a single-switch forward converter or a single-switch flyback converter, is widely used. It includes an isolation transformer, a switch on a primary side of the transformer, a rectifier and an output filter on a secondary side of the transformer. By way of the on/off control of the power switch, an AC voltage is generated in the transformer primary from input DC voltage and converted to another value in the transformer secondary. After being rectified and filtered, DC output power with different voltage/current combinations can be obtained.

An issue of concern regarding aforementioned converters is that a magnetizing and the leakage energies stored in the transformer must be taken into consideration during the design of the converter. Otherwise, these magnetic energies stored in the transformer may cause the failure of the converter.

Another issue of concern regarding aforementioned converters is to alleviate the electromagnetic interference EMI problems. Part of the EMI problems is caused by the pulsating current ripples, di/dt, in the power converters. Also, the lower the pulsating current ripples, the lower the RMS value of the current. As a result, conduction losses can be reduced to improve the efficiency. Therefore, a power converter with a low input current ripple becomes one of the design criteria of concern.

To achieve a low current ripple as well as to recycle the transformer's magnetizing and leakage energies, several power converters have been proposed in the literatures and become the prior art of the present invention.

One of which shown in FIG. 1 is the power converter proposed for low power level applications in “Design Tricks, Techniques and Tribulation at High Conversion Frequencies,” Bruce Carsten, HFPC 1987, pp. 139-152 and is also described in “Snubber Circuits: Theory, Design and Application,” Philip C. Todd, TI seminar 900. Topic 2, 1993. Recently, its input current ripple reduction property has been explored by the inventor of the present invention in “Improved Forward Topologies for DC-DC Applications with Built-in Input Filter,” Ph.D. dissertation, Virginia Polytechnic & State University, Blacksburg, Va., U.S.A, 2006.

However, this circuit contains a single switch which is selected to withstand twice the input voltage. In some applications, ample voltage-rating semiconductor switches may be available at the cost of increasing the conduction losses due to the higher voltage-rating semiconductor switch accompanied with a higher R_{DSon}. On the contrary, voltage stress may be too high for available semiconductor switches in many other applications.

By series-connecting two semiconductor switches, the voltage stress on each device can be reduced. Using low-voltage rating semiconductor switch, the equivalent R_{DS(ON)} is reduced. As a result, the conduction losses can be significantly reduced and improve the converter's efficiency. As shown in FIG. 2, an invented power converter has been filed with the U.S. patent Ser. No. 11/812,339 application number on Jun. 18, 2007 by the inventor of the present invention, which is incorporated herein by reference. Each of the two series-connected semiconductor switches has been designed to accommodate rated for approximately the input voltage.

To further reduce the input/output current ripple by means of the ripple cancellation mechanism, another one of which is shown in FIG. 3. It was invented in U.S. Pat. No. 5,523,936, issued on Jun. 4, 1996, to the inventor of the present invention.

Again, to take the advantage of reducing the voltage stress, the circuit diagram of its two-switch version is shown in FIG. 4. It has been filed with the U.S. patent Ser. No. 11/812,339 application number on Jun. 18, 2007, by the inventor of the present invention.

Because the transformer reset voltage of the aforementioned power converters is equal to the input voltage, a maximum duty cycle is limited to 50%. The turns ratio of the transformer is thus restricted to a smaller value resulting in accompanying with a higher RMS input current and higher rectifier's voltage stress. Consequently, the conduction losses are increased.

Accordingly, those skilled in the art understand that one of the effects of increasing the duty cycle of the power switch is that an overall efficiency of the power converter can be increased.

A system and method is thus needed to maximize the converter's efficiency by means of recovering the magnetic energies, decreasing the current ripple, reducing voltage stress, and allowing above 50% duty cycle operation.

### SUMMARY OF THE INVENTION

Accordingly, an object of the present invention is to provide inversion circuits having reduced input current ripple thereby to alleviate the EMI problems and to improve the converter's efficiency.

A further object of the present invention is to provide inversion circuits employing clamped capacitor to recycle the magnetic energies thereby to improve the converter's efficiency.

A further object of the present invention is to provide inversion circuits using low voltage-rating semiconductor switch thereby to improve the converter's efficiency.

A further object of the present invention is to provide inversion circuits surpassing 50% duty cycle thereby to improve the converter's efficiency.

The present invention therefore introduces the broad concept of resetting a transformer by transferring energy to reset windings via at least two capacitors of the power converter circuit. In one embodiment of the present invention, a power converter comprises two series circuits, one capacitor, and one transformer. The transformer has at least two identical primary windings and at least one secondary winding. Both series circuits are connected in parallel with the DC input source Vi. The first series circuit includes the first transformer primary winding and one switch network; while the second series circuit includes the voltage-clamp network and the secondary transformer primary winding. The switch network comprises at least one semiconductor switch and the voltage-clamp network comprises at least one active or one passive voltage-clamp cell. The active voltage-clamped cell is formed by a MOSFET series-connected with a capacitor (MOSFET-Capacitor) while the passive voltage-clamp cell is formed by a diode or a resistor parallel-connected to a capacitor with series-connecting to a diode. The capacitor is used to couple the first and the second series circuits by connecting a first node and a second node, wherein the first node is a node between the switch network and the first transformer primary, and the second node is a node between the voltage-clamp network and the second transformer primary. One driver signal is issued by the gate drive to turn on/off the semiconductor switch within the switch network. Consequently, an AC voltage is thus generated in the transformer secondary winding. After being rectified and filtered (not shown), the output of the power converter provides an output voltage Vo to a load.

The capacitor voltage and the voltage across the voltage-clamp network are summed together to be the transformer reset voltage. Because the voltages across the two transformer primary windings are canceled each other due to their opposite-parity, the capacitor voltage is the same level as the input voltage. Thus, the reset voltage is higher than the input voltage and the maximum duty cycle of the power switch can be exceeded 50%. Those skilled in the art understand that one of the effects of increasing the duty cycle of the power switch is that an overall efficiency of the power converter can be increased.

To accomplish desired function, two series-connected semiconductor switches may be substituted for the switch network and two series-connected active and/or passive cells may be substituted for the voltage-clamp network. Moreover, the center nodes between two active and/or passive cells and two series-connected semiconductor switches are connected together to provide an individual clamped voltage on each of the two series-connected semiconductor switches. In addition, two driver signals are issued by the gate drive to turn on/off the two semiconductor switches within the switch network simultaneously. Also, at least one complementary signal issued by the gate drive is necessarily provided to drive the semiconductor switch within the voltage-clamp network. Moreover, two capacitors and/or two transformers may be used instead of using a single capacitor and/or a single transformer, respectively.

Several embodiments of the present invention can thus be obtained. However, in one embodiment of the present invention, the voltage-clamp network formed by one single diode or multiple diodes is not necessary to the present invention.

In order to make the aforementioned and other objects, features and advantages of the present invention comprehensible, several preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1, FIG. 2, FIG. 3, and FIG. 4 are the circuit diagrams of the power converter as prior art of the present invention.

FIG. 5 is the first circuit diagram of the present invention.

FIG. 5A and FIG. 5J illustrate ten embodiments of the power converter accordance with the present invention.

FIG. 6 is the second circuit diagram of the present invention.

FIG. 6A and FIG. 6J illustrate another ten embodiments of the power converter accordance with the present invention.

FIG. 7 is the third circuit diagram of the present invention.

FIG. 7A and FIG. 7J illustrate another ten embodiments of the power converter accordance with the present invention.

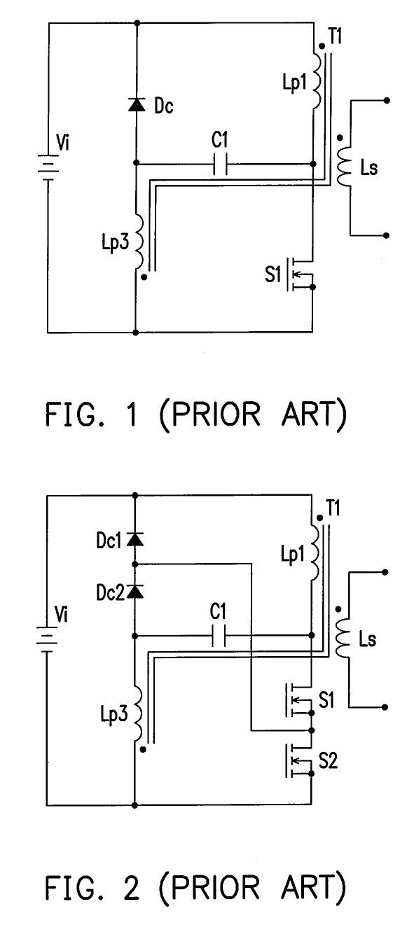

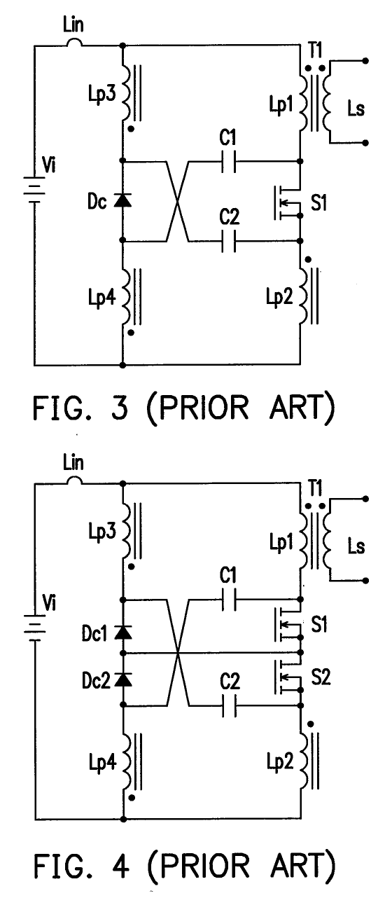

### DESCRIPTION OF EMBODIMENTS

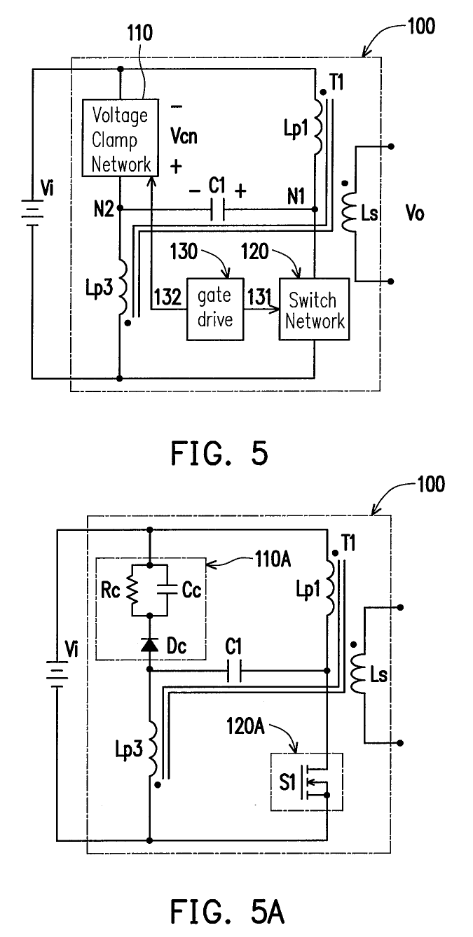

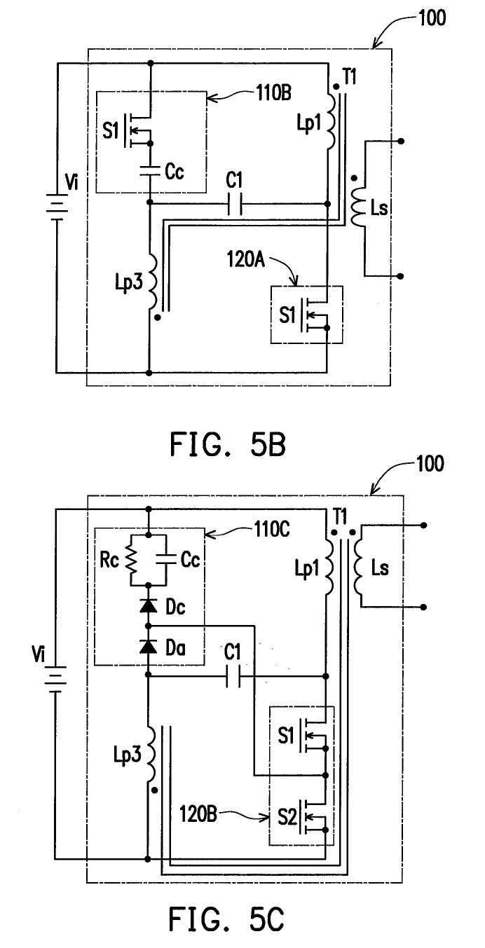

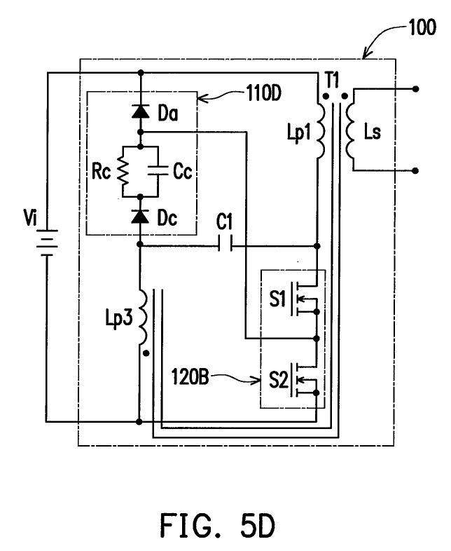

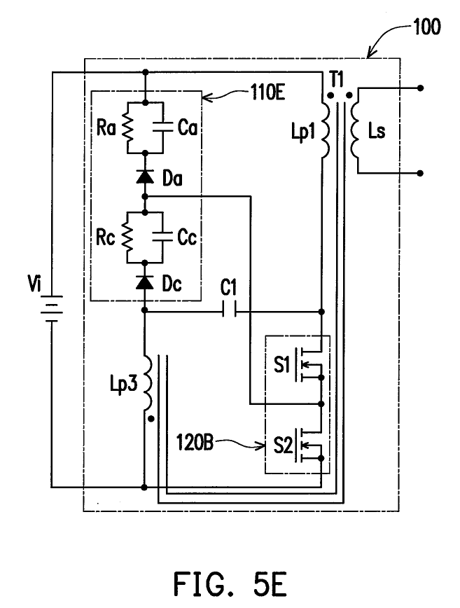

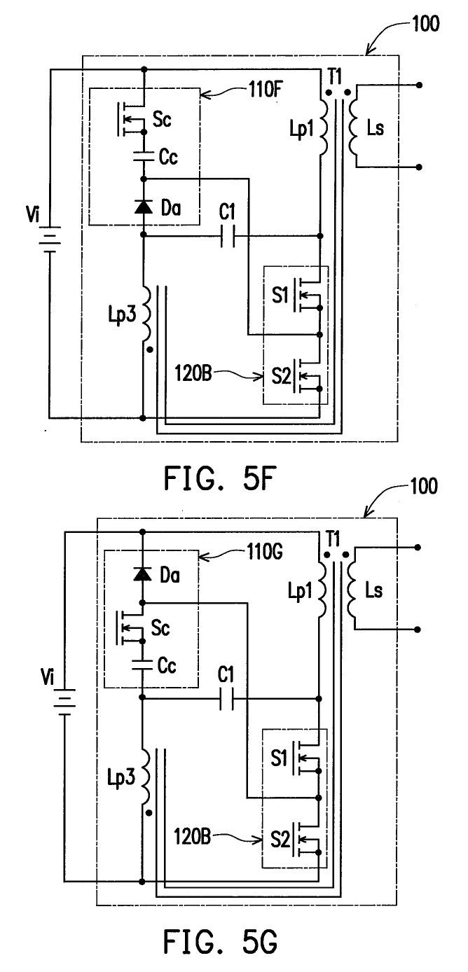

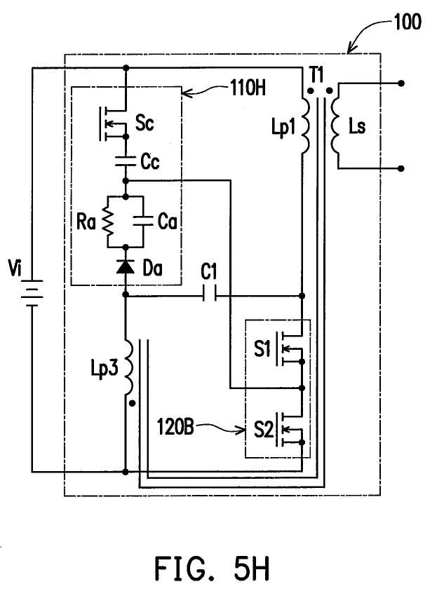

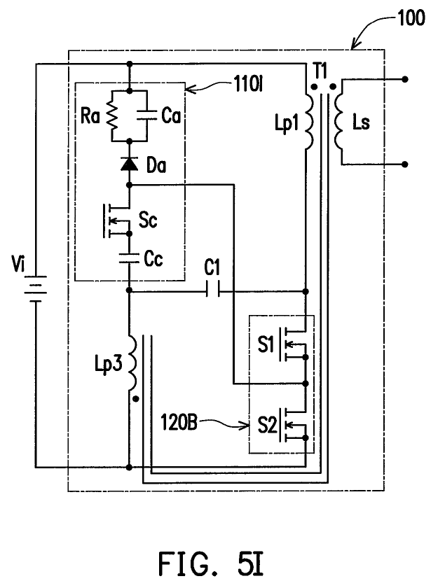

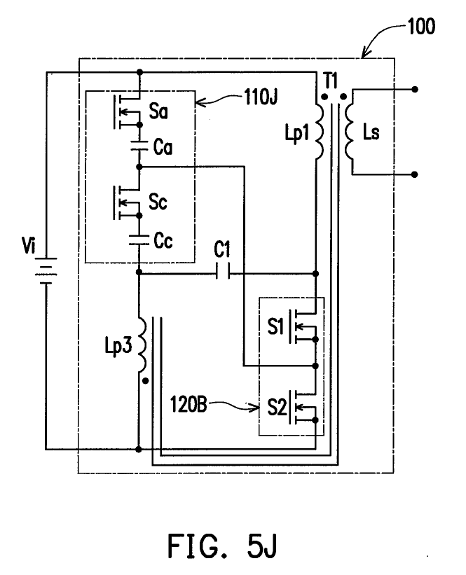

As illustrated in FIG. 5 is a circuit diagram of the power converter 100 to introduce the broad concept of resetting a transformer by transferring energy to reset winding via the capacitors of the present invention. The circuit used to convert a DC input to an AC output comprises two series circuits, one capacitor C1, and one transformer T1. The transformer T1 has two identical primary windings Lp1 and Lp3 and at least one secondary winding Ls. Both series circuits are connected in parallel with the DC input source Vi. The first series circuit comprises the first transformer primary winding Lp1 and one switch network 120; while the second series circuit comprises the voltage-clamp network 110 and the secondary transformer primary winding Lp3. The switch network 120 comprises at least one semiconductor switch and the voltage-clamp network 110 comprises at least one active or one passive voltage-clamp cell. The active voltage-clamp cell is formed by a MOSFET Sc series-connected with a capacitor Cc (MOSFET-Capacitor) while the passive voltage-clamp cell is formed by a resistor Rc parallel-connected to a capacitor Cc with series-connecting to a diode Dc. The capacitor C1 is used to couple the first and the second series circuits by connecting a first node N1 and a second node N2, wherein the first node N1 is a node between the switch network 120 and the first transformer primary Lp1, and the second node N2 is a node between the voltage-clamp network 110 and the second transformer primary Lp3. Because the voltages across the first and second transformer primary windings are cancelled each other, the capacitor C1 voltage level is equal to the input voltage Vi. At least one driver signal 131 is issued by the gate drive 130 to turn on or turn off the semiconductor switch within the switch network 120. Consequently, an AC voltage is generated in the secondary winding Ls. After being rectified and filtered (not shown), the output of the power converter provides an output voltage Vo to a load.

The power converter 100 operates as follows. During a first interval, at least one gate drive signal 131 is issued to turn on the semiconductor switch within the switch network 120. In addition to the input voltage Vi applied to the primary winding Lp1, the capacitor voltage V_{C1} is also applied to the second winding Lp3. A magnetizing current associated with the transformer T1 increases linearly. Then, during a complementary interval, the gate drive signal 131 turns off the semiconductor switch within the switch network 120. The energy stored in the leakage inductance of the transformer T1 is absorbed by the capacitor C1 and the capacitor Cc within the voltage-clamp network 110. Therefore, the voltage across the switch network 120 has no voltage spike and is limited to the sum of the three voltages provided by the capacitor C1, the capacitor Cc within the voltage-clamp network 100, and the input voltage Vi. The magnetizing and leakage energies are then recovered to the input via the second winding Lp3 and the voltage-clamp network 110, thereby resetting the transformer T1.

The transformer reset voltage is equal to the sum of the voltages across the capacitor C1 and the capacitor Cc within the voltage-clamp network 100. Because the voltage across the capacitor C1 is clamped to input voltage Vi, the reset voltage is higher than the input voltage. The duty cycle of the semiconductor switch within the switch network 120, therefore, can be above 50%.

Obviously, a higher than 50% operating duty cycle results in increasing transformer turns ratio accompanied with a low primary current and lower voltage stresses on the secondary rectifiers. Consequently, further improvements of the power converter's efficiency can be achieved.

Turning now to FIG. 5A and FIG. 5B are two embodiments of power converter constructed according to the foregoing principles of the present invention. The voltage-clamp network 110A is a passive voltage-clamp cell formed by a R_{C}-C_{C}-D_{C} sub-circuit, as shown in FIG. 5A, and the voltage-clamp network 110B is an active voltage-clamp cell formed by a Sc-Cc sub-circuit, as shown in FIG. 5B, respectively. One complementary signal 132 issued by the gate drive 130 is necessarily provided to drive the semiconductor switch Sc within the voltage-clamp network 110B.

Another two embodiments of power converter constructed according to the foregoing principles of the present invention are shown in FIG. 5C and FIG. 5D. The voltage-clamp networks 110C and 110D comprise two series-connected passive voltage-clamp cells formed by the combination of a diode Dₐ and a R_{C}-C_{C}-D_{C} sub-circuits. Depends on the configuration, the voltage across the switch S1 or S2 within the switch network 120 is clamped to Vi or Vi+V_{CC}.

Another one embodiment of power converter constructed according to the foregoing principles of the present invention are shown in FIG. 5E. The voltage-clamp network 110E comprises two series-connected passive voltage-clamp cells formed by a R_{C}-C_{C}-D_{C} sub-circuit and a Ra-Ca-Da sub-circuit. The voltage across the switch S1 or S2 within the switch network 120 is clamped to Vi+V_{Ca} and Vi+V_{CC}, respectively.

Another two embodiments of power converter constructed according to the foregoing principles of the present invention are shown in FIG. 5F and FIG. 5G. The voltage-clamp networks 110F and 110G comprise two series-connected voltage-clamp cells formed by the combination of a diode Da and a MOSFET-Capacitor (Sc-Cc) sub-circuit. One complementary signal 132 issued by the gate drive 130 is necessarily provided to drive the semiconductor switch Sc within the voltage-clamp network 110F or 110G. Depends on the configuration, the voltage across the switch S1 or S2 within the switch network 120 is clamped to Vi or Vi+V_{CC}.

Another two embodiments of power converter constructed according to the foregoing principles of the present invention are shown in FIG. 5H and FIG. 5I. The voltage-clamp networks 110H and 110I comprise two series-connected voltage-clamp cells formed by the combination of a R_{C}-C_{C}-D_{C} sub-circuit and a Sc-Cc sub-circuit. One complementary signal 132 issued by the gate drive 130 is necessarily provided to drive the semiconductor switch Sc within the voltage-clamp network 110H or 110I. Depends on the configuration, the voltage across the switch S1 or S2 within the switch network 120 is clamped to Vi+V_{CC} or Vi+V_{Ca}.

Another one embodiment of power converter constructed according to the foregoing principles of the present invention is shown in FIG. 5J. The voltage-clamp networks 110J comprise two series-connected voltage-clamp cells formed by a Sc-Cc sub-circuit and a Sa-Ca sub-circuit. Two complementary signals 132 issued by the gate drive 130 are necessarily provided to drive the semiconductor switch Sc and Sa within the voltage-clamp network 110J. Depends on the configuration, the voltage across the switch S1 or S2 within the switch network 120 is clamped to Vi+V_{CC} or Vi+V_{Ca}.

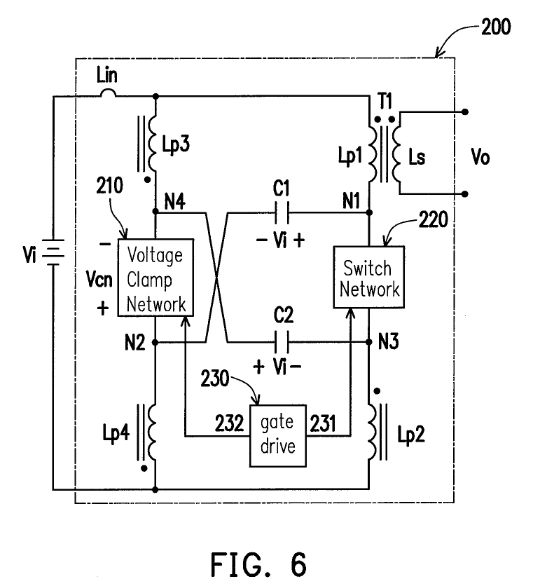

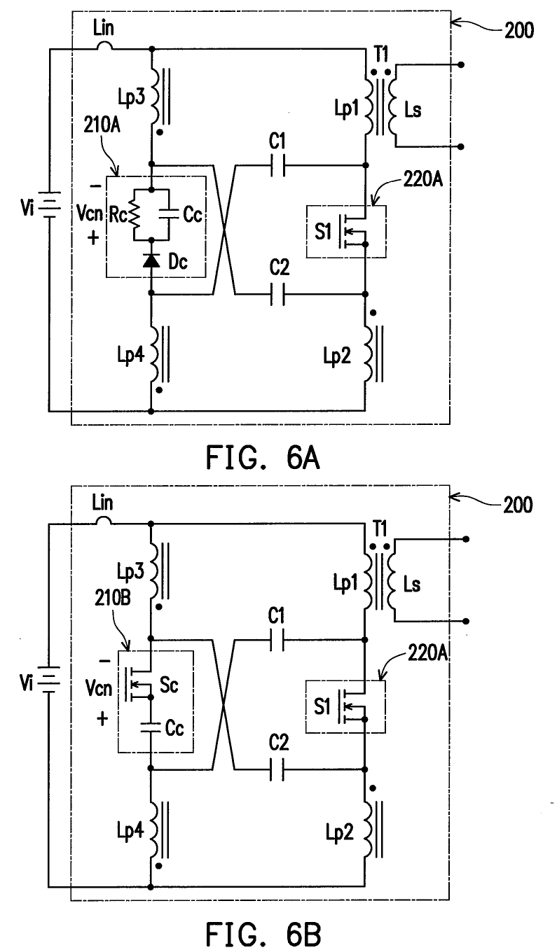

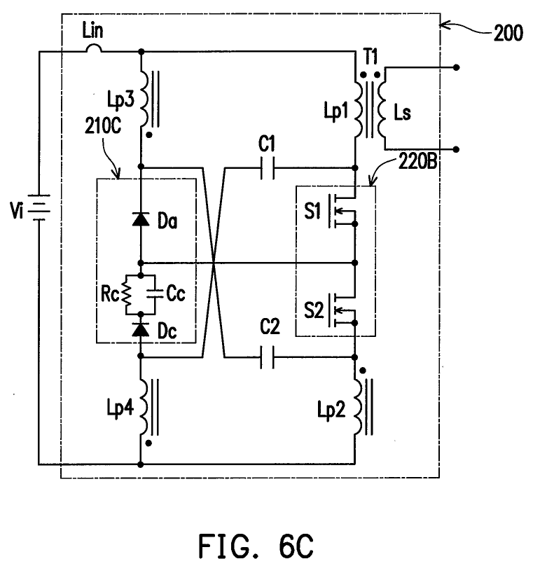

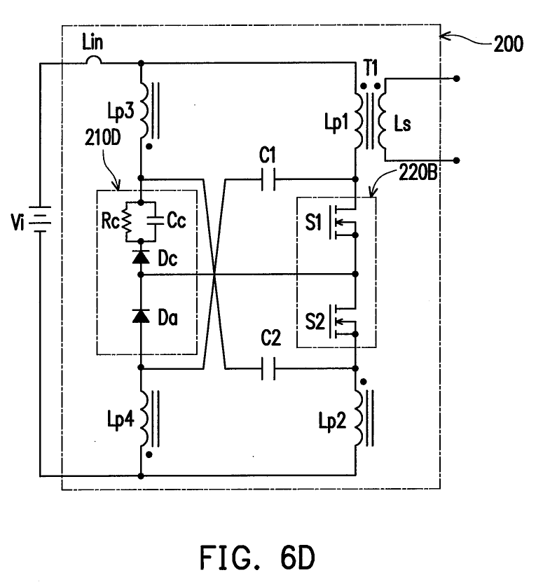

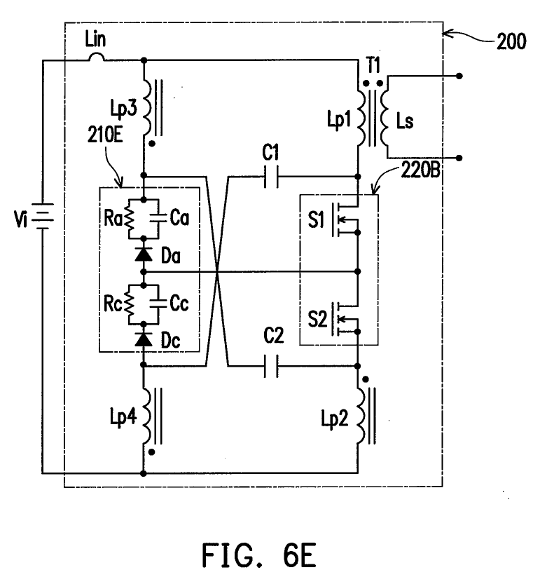

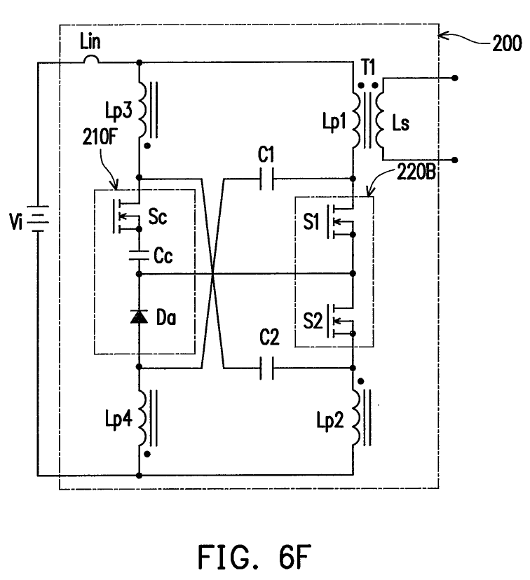

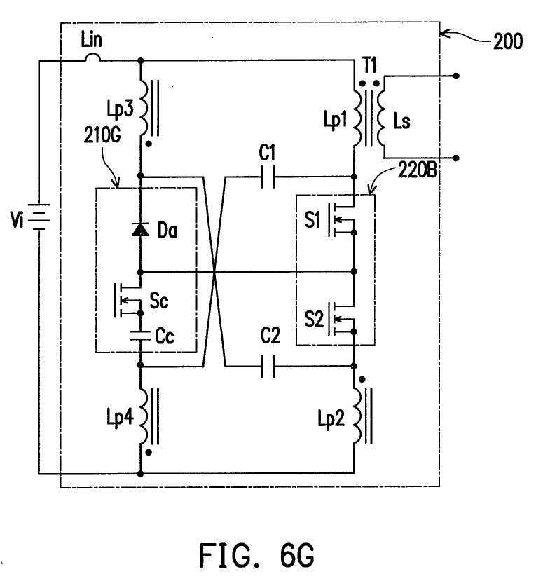

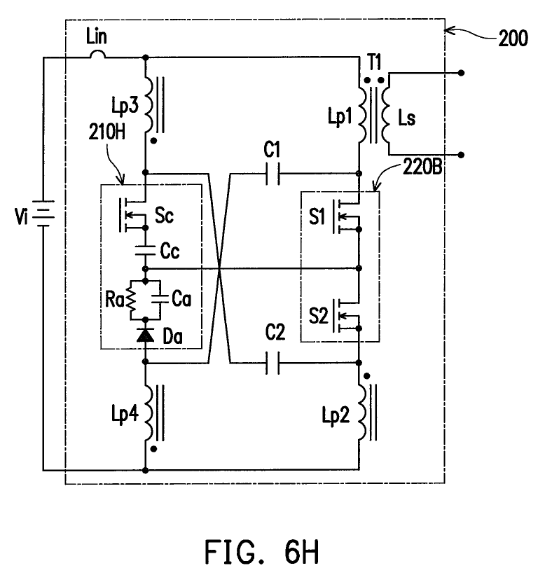

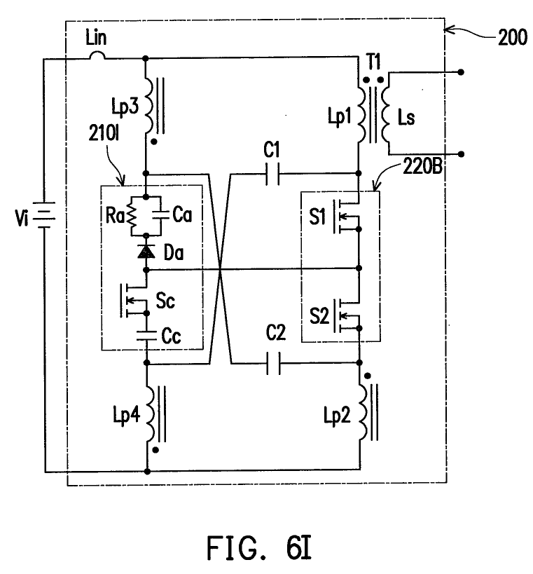

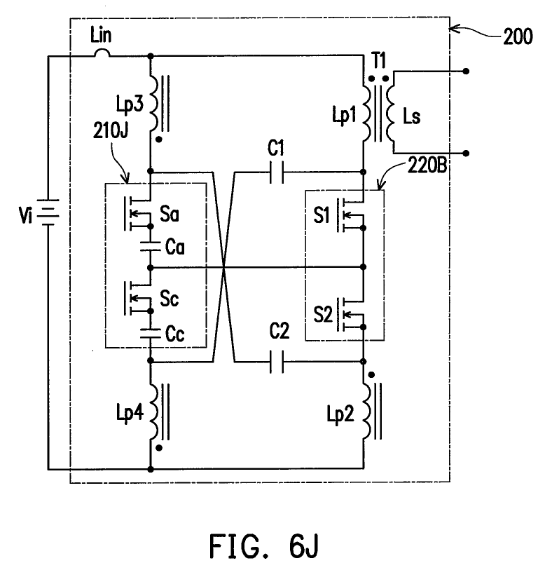

As illustrated in FIG. 6 is another circuit diagram of the power converter 200 to introduce the broad concept of resetting a transformer by transferring energy to reset winding via the capacitors as well as to further reduce the current ripple of the present invention. The circuit used to convert a DC input to an AC output comprises two series circuits, two capacitors (C1 and C2), and one transformer T1. The input inductor, Lᵢₙ represented the parasitic inductor or an external inductor, as designed, is inserted between the DC input Vi and the two series circuits. The transformer T1 has four identical primary windings Lp1, Lp2, Lp3 and Lp4 and has at least one secondary winding Ls. Both series circuits are connected in parallel with the DC input source Vi. The first series circuit comprises the first and the second transformer primaries Lp1 and Lp2 and one switch network 220. The second series circuit comprises a voltage-clamp network 210 and the third and the fourth transformer primaries Lp3 and Lp4. The switch network 220 comprises at least one semiconductor switch and the voltage-clamp network 210 comprises at least one active or one passive voltage-clamp cell. The active voltage-clamp cell is formed by a MOSFET Sc series-connected with a capacitor Cc while the passive voltage-clamp cell is formed by a diode Da or a resistor Rc parallel-connected to a capacitor Cc with series-connecting to a diode Dc. The first capacitor C1 is used to couple the first and the second series circuits by connecting a first node N1 and a second node N1, wherein the first node N1 is a node between the switch network 220 and the first transformer primary Lp1, and the second node N2 is a node between the voltage-clamp network 210 and the fourth transformer primary Lp4. The second capacitor C2 is used to couple the first and the second series circuits by connecting a third node N3 and a fourth node N4, wherein the third node N3 is a node between the switch network 220 and the second transformer primary Lp2, and the fourth node N4 is a node between the voltage-clamp network 210 and the third transformer primary Lp3. Because the voltages across the transformer primary windings Lp1 and Lp3 (Lp2 and Lp3) are cancelled each other, each capacitor voltage level is equal to the input voltage. At least one driver signal 231 is issued by the gate drive 230 to turn on or turn off the at least one semiconductor switch within the switch network 220. Consequently, an AC voltage is generated in the secondary winding Ls. After being rectified and filtered (not shown), the output of the power converter provides an output voltage Vo to a load.

The power converter 200 operates as follows. During a first interval, a gate drive signal 231 is issued to turn on the semiconductor switch within the switch network 220. In addition to the input voltage Vi applied to the primary windings Lp1-Lp2, each capacitor voltage is also applied to its individual pair of primary winding Lp2-Lp4 or Lp1-Lp3, respectively. A magnetizing current associated with the transformer T1 increases linearly. Then, during a complementary interval, the gate drive signal 231 turns off the semiconductor switch within the switch network 220. The energy stored in the leakage inductance of the transformer T1 is absorbed by the capacitors C1 and C2 as well as the capacitor within the voltage-clamp network 210. Therefore, the voltage across the switch network 220 has no voltage spike and limited to the sum of the three voltages provided by the capacitor C1, the capacitor C2, and the capacitor within the voltage-clamp network 200. The magnetizing and leakage energies are then recovered to the input via the third primary winding Lp3, the fourth primary windings Lp4, and the voltage-clamp network 210, thereby resetting the transformer T1.

The transformer reset voltage is equal to the sum of the capacitor voltage (C1 or C2) and the capacitor voltage within the voltage-clamp network 210. Because the voltage across each capacitor (C1 or C2) is clamped to input voltage Vi, the reset voltage is higher than the input voltage. The duty cycle of the semiconductor switch within the switch network 220, therefore, can be above 50%.

Obviously, a higher than 50% operating duty cycle results in increasing transformer turns ratio accompanied with a low primary current and lower voltage stresses on the secondary rectifiers. Consequently, further improvements of the power converter's efficiency can be achieved.

Turning now to FIG. 6A and FIG. 6B are two embodiments of power converter constructed according to the foregoing principles of the present invention. The voltage-clamp network 210A is a passive voltage-clamp cell formed by a R_{C}-C_{C}-D_{C} sub-circuit and the voltage-clamp network 210B is an active voltage-clamp cell formed by a Sc-Cc sub-circuit, respectively. One complementary signal 232 issued by the gate drive 230 is necessarily provided to drive the semiconductor switch Sc within the voltage-clamp network 210B.

Another two embodiments of power converter constructed according to the foregoing principles of the present invention are shown in FIG. 6C and FIG. 6D. The voltage-clamp networks 210C and 210D comprise two series-connected passive voltage-clamp cells formed by the combination of a diode Dₐ and a R_{C}-C_{C}-D_{C} sub-circuit. Depends on the configuration, the voltage across the switch S1 or S2 within the switch network 220 is clamped to Vi or Vi+V_{CC}.

Another one embodiment of power converter constructed according to the foregoing principles of the present invention are shown in FIG. 6E. The voltage-clamp network 210E comprises two series-connected passive voltage-clamp cells formed by a R_{C}-C_{C}-D_{C} sub-circuit and a Ra-Ca-Da sub-circuit. The voltage across the switch S1 or S2 within the switch network 220 is clamped to Vi+V_{Ca} and Vi+V_{CC}, respectively.

Another two embodiments of power converter constructed according to the foregoing principles of the present invention are shown in FIG. 6F and FIG. 6G. The voltage-clamp networks 210F and 210G comprise two series-connected voltage-clamp cells formed by the combination of a diode Da and a Sc-Cc sub-circuit. One complementary signal 232 issued by the gate drive 210 is necessarily provided to drive the semiconductor switch Sc within the voltage-clamp network 210F or 210G. Depends on the configuration, the voltage across the switch S1 or S2 within the switch network 220 is clamped to Vi or Vi+V_{CC}.

Another two embodiments of power converter constructed according to the foregoing principles of the present invention are shown in FIG. 6H and FIG. 6I. The voltage-clamp networks 210H and 210I comprise two series-connected voltage-clamp cells formed by the combination of a Rₐ-Cₐ-Dₐ sub-circuit and a Sc-Cc sub-circuit. One complementary signal 232 issued by the gate drive 210 is necessarily provided to drive the semiconductor switch Sc within the voltage-clamp network 210H or 210I. Depends on the configuration, the voltage across the switch S1 or S2 within the switch network 220 is clamped to Vi+V_{Cc} or Vi+V_{Ca}.

Another one embodiment of power converter constructed according to the foregoing principles of the present invention is shown in FIG. 6J. The voltage-clamp networks 210J comprise two series-connected voltage-clamp cells formed by a Sc-Cc sub-circuit and a Sa-Ca sub-circuit. Two complementary signals 232 issued by the gate drive 230 are necessarily provided to drive the semiconductor switch Sc and Sa within the voltage-clamp network 210J. Depends on the configuration, the voltage across the switch S1 or S2 within the switch network 220 is clamped to Vi+V_{CC} or Vi+V_{Ca}.

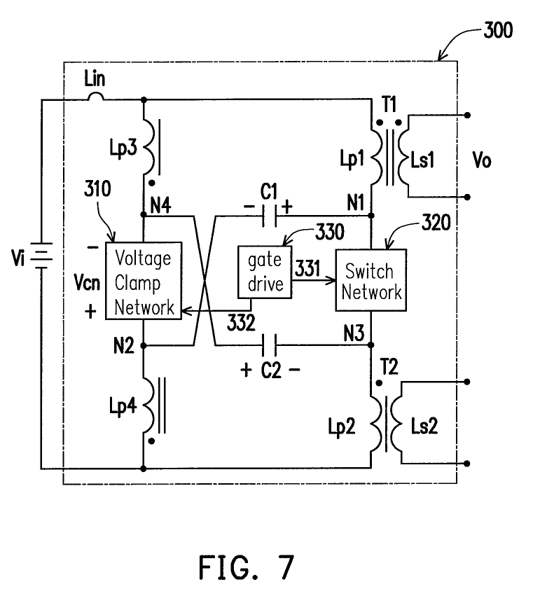

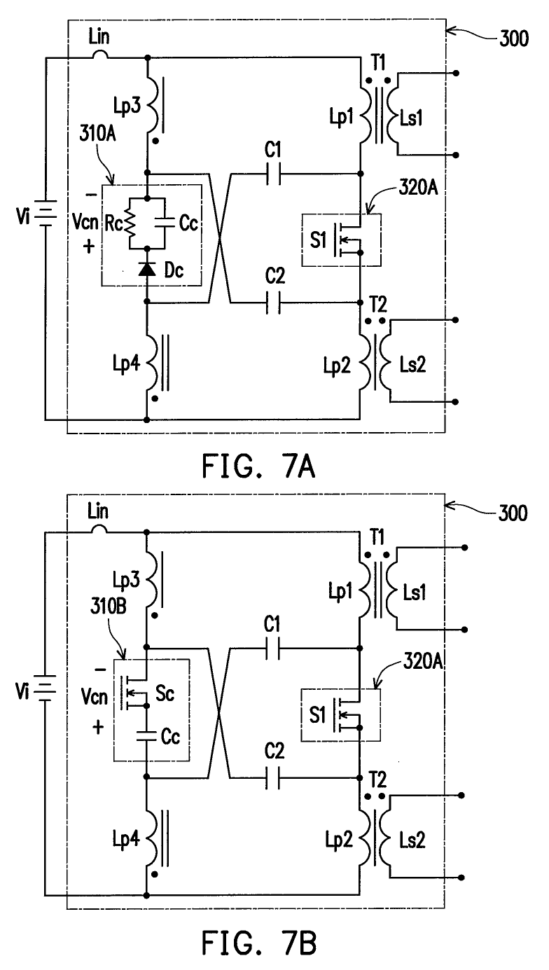

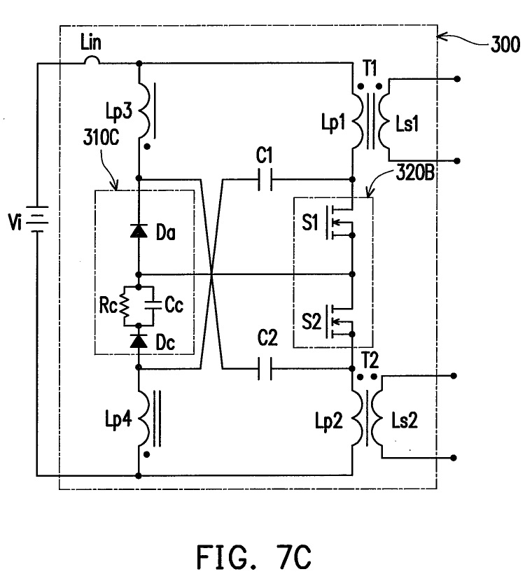

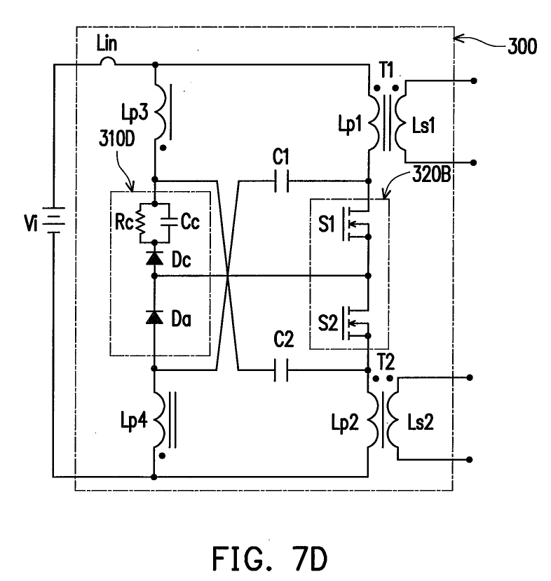

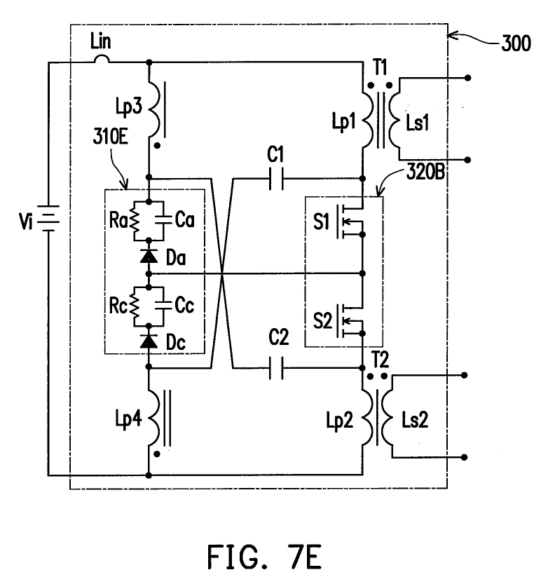

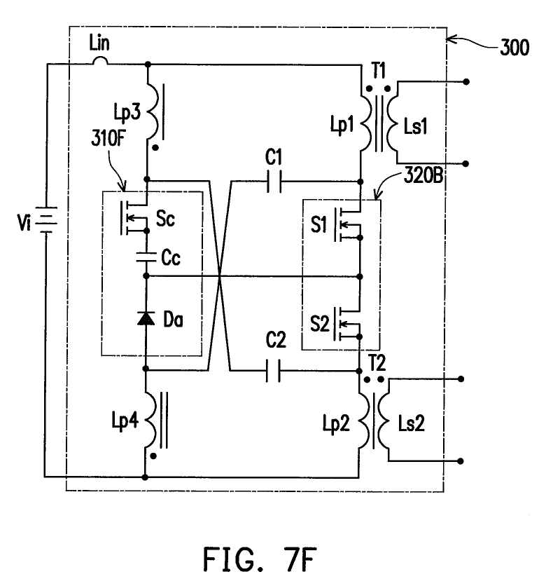

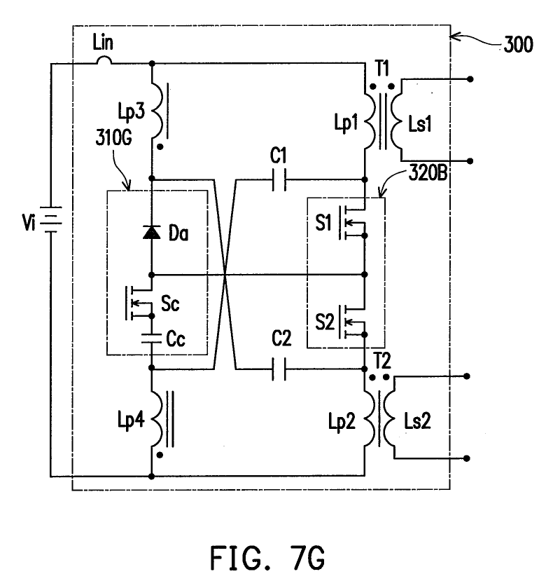

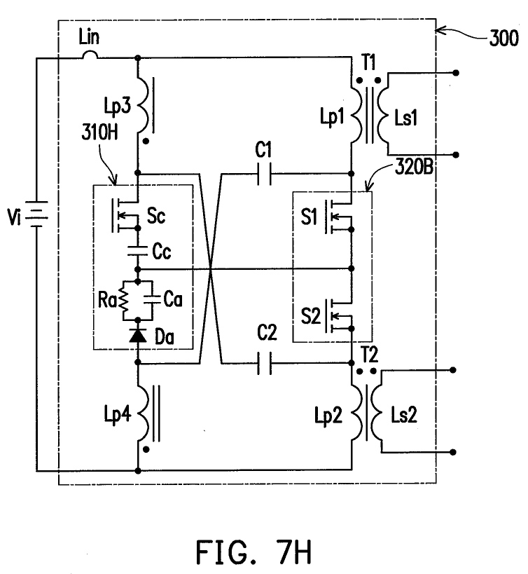

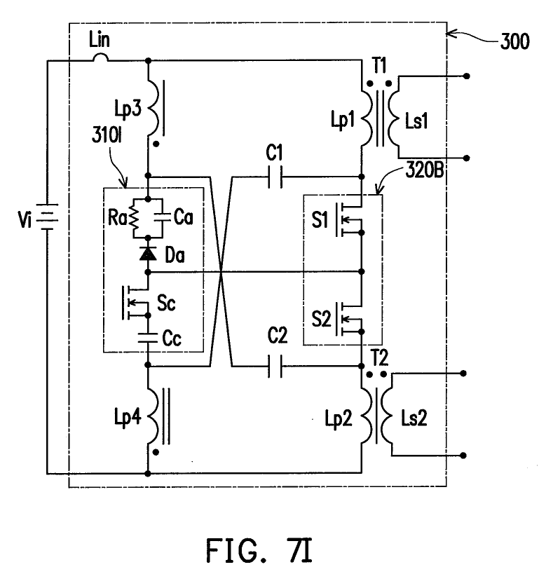

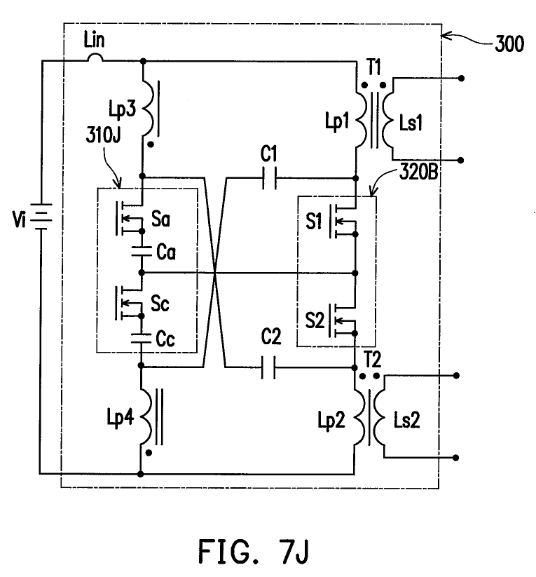

As illustrated in FIG. 7 is another circuit diagram of the power converter 300 to introduce the broad concept of resetting a transformer by transferring energy to reset winding via the capacitors and to further reduce the current ripple as well as to alleviate the thermal stress of the transformer of the present invention. The power converter 300 used to convert a DC input to an AC output comprises one input inductor, two series circuits, two capacitors C1 and C2, and two transformers T1 and T2. The input inductor, Lᵢₙ represented the parasitic inductor or an external inductor, as designed, is inserted between the DC input Vi and the two series circuits. The transformer T1 has two identical primary windings Lp1 and Lp4 and has at least one secondary winding Ls1; while the transformer T2 has two identical primary windings Lp2 and Lp3 and has at least one secondary winding Ls2. Each series circuit is connected in parallel with the DC input source Vi. The first series circuit comprises the first primary Lp1 of the first transformer T1, the first primary Lp2 of the second transformer T2, and one switch network 320. The second series circuit comprises the second primary Lp4 of the first transformer T1, the second primary Lp3 of the second transformer T2, and the voltage-clamp network 310. The switch network 320 comprises at least one semiconductor switch and the voltage-clamp network 310 comprises at least one active or one passive voltage-clamp cell. The active voltage-clamp cell is formed by a MOSFET Sc series-connected with a capacitor Cc; while the passive voltage-clamp cell is formed by a diode Da or a resistor Rc parallel-connected to a capacitor Cc with series-connecting to a diode Dc. The first capacitor C1 is used to couple the first and the second series circuits by connecting a first node N1 and a second node N2, wherein the first node N1 is a node between the switch network 320 and the first primary Lp1 of the first transformer T1, and the second node N2 is a node between the voltage-clamp network 310 and the first primary Lp4 of the first transformer T1. The second capacitor C2 is used to couple the first and the second series circuits by connecting a third node N3 and a fourth node N4, wherein the third node N3 is a node between the switch network 320 and the first primary Lp2 of the second transformer T2, and the fourth node N4 is a node between the voltage-clamp network 310 and the second primary Lp3 of the transformer T2. Because the voltages across the transformer primary windings Lp1 and Lp3 (Lp2 and Lp3) are cancelled each other, each capacitor voltage level is equal to the input voltage. At least one driver signal 331 is issued by the gate drive 330 to turn on/off the at least one semiconductor switch within the switch network 320. Consequently, two AC voltages are generated in the secondary windings (Ls1 and Ls2). After series-connecting or paralleled-connecting Ls1 and Ls2 and being rectified and filtered (not shown), the power converter provides an output voltage Vo to a load.

The power converter 300 operates as follows. During a first interval, a gate drive signal 331 is issued to turn on the semiconductor switch within the switch network 320. In addition to the input voltage Vi applied to the primary windings Lp1-Lp2, each capacitor voltage is also applied to its individual pair of the primary winding Lp2-Lp4 or Lp1-Lp3, respectively. Then, during a complementary interval, the gate drive signal 331 turns off the semiconductor switch within the switch network 320. The energy stored in the leakage inductance of the transformer T1 is absorbed by the capacitors C1 and C2 as well as the capacitor within the voltage-clamp network 310. Therefore, the voltage across the switch network 320 has no voltage spike and limited to the sum of the three voltages provided by the capacitor C1, the capacitor C2, and the capacitor within the voltage-clamp network 310. The magnetizing and leakage energies are then recovered to the input via the third primary winding Lp3, the fourth primary windings Lp4, and the voltage-clamp network 310, thereby resetting the transformer T1.

The transformer reset voltage is equal to the sum of the capacitor voltage (C1 or C2) and the capacitor voltage within the voltage-clamp network 310. Because the voltage across each capacitor (C1 or C2) is clamped to input voltage Vi, the reset voltage is higher than the input voltage. The duty cycle of the semiconductor switch within the switch network 320, therefore, can be above 50%.

Obviously, a higher than 50% operating duty cycle results in increasing transformer turns ratio accompanied with a low primary current and lower voltage stresses on the secondary rectifiers. Consequently, further improvements of the power converter's efficiency can be achieved.

Turning now to FIG. 7A and FIG. 7B are two embodiments of power converter constructed according to the foregoing principles of the present invention. The voltage-clamp network 310A is a passive voltage-clamp cell formed by a R_{C}-C_{C}-D_{C} sub-circuit and the voltage-clamp network 310B is an active voltage-clamp cell formed by a Sc-Cc sub-circuit, respectively. One complementary signal 332 issued by the gate drive 330 is necessarily provided to drive the semiconductor switch Sc within the voltage-clamp network 310B.

Another two embodiments of power converter constructed according to the foregoing principles of the present invention are shown in FIG. 7C and FIG. 7D. The voltage-clamp networks 310C and 310D comprise two series-connected passive voltage-clamp cells formed by the combination of a diode Dₐ and a R_{C}-C_{C}-D_{C} sub-circuit. Depends on the configuration, the voltage across the switch S1 or S2 within the switch network 320 is clamped to Vi or Vi+V_{CC}.

Another one embodiment of power converter constructed according to the foregoing principles of the present invention are shown in FIG. 7E. The voltage-clamp network 310E comprises two series-connected passive voltage-clamp cells formed by a R_{C}-C_{C}-D_{C} sub-circuit and a Ra-Ca-Da sub-circuit. The voltage across the switch S1 or S2 within the switch network 320 is clamped to Vi+V_{Ca} and Vi+V_{CC}, respectively.

Another two embodiments of power converter constructed according to the foregoing principles of the present invention are shown in FIG. 7F and FIG. 7G. The voltage-clamp networks 310F and 310G comprise two series-connected voltage-clamp cells formed by the combination of a diode Da and a Sc-Cc sub-circuit. One complementary signal 332 issued by the gate drive 330 is necessarily provided to drive the semiconductor switch Sc within the voltage-clamp network 310F or 310G. Depends on the configuration, the voltage across the switch S1 or S2 within the switch network 320 is clamped to Vi or Vi+V_{CC}.

Another two embodiments of power converter constructed according to the foregoing principles of the present invention are shown in FIG. 7H and FIG. 7I. The voltage-clamp networks 31 OH and 310I comprise two series-connected voltage-clamp cells formed by the combination of a Rₐ-Cₐ-Dₐ sub-circuit and a Sc-Cc sub-circuit. One complementary signal 332 issued by the gate drive 330 is necessarily provided to drive the semiconductor switch Sc within the voltage-clamp network 310H or 310I. Depends on the configuration, the voltage across the switch S1 or S2 within the switch network 320 is clamped to Vi+V_{CC} or Vi+V_{Ca}.

Another one embodiment of power converter constructed according to the foregoing principles of the present invention is shown in FIG. 7J. The voltage-clamp networks 310J comprise two series-connected voltage-clamp cells formed by a Sc-Cc sub-circuit and a Sa-Ca sub-circuit. Two complementary signals 332 issued by the gate drive 330 are necessarily provided to drive the semiconductor switch Sc and Sa within the voltage-clamp network 310J. Depends on the configuration, the voltage across the switch S1 or S2 within the switch network 320 is clamped to Vi+V_{CC} or Vi+V_{Ca}.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed:

1. A circuit to convert a DC voltage received at a DC input to an AC voltage, the circuit comprising:
a first series circuit connected in parallel with said DC input and comprising a switch network and a first transformer primary;
a second series circuit connected in parallel with said DC input and comprising a voltage-clamp network and a second transformer primary;
a capacitor connected between a first node within said first series circuit and a second node within said second series circuit, wherein said first node is between said first transformer primary and said switch network, and wherein said second node is between said voltage-clamp network and said second transformer primary; and
at least one of said transformer secondaries magnetically coupled to said first transformer primary and said second transformer primary and providing said AC voltage.

2. The circuit as claimed in claim 1, wherein said first transformer primary and said second transformer primary are primaries of a common transformer, and are magnetically coupled to a same transformer core.

3. The circuit as claimed in claim 1, wherein said switch network comprises one MOSFET or one other active semiconductor switch with parallel-connected diode, wherein said voltage-clamp network comprises a resister-capacitor-diode sub-circuit, or a MOSFET-capacitor sub-circuit.

4. The circuit as claimed in claim 1, wherein said switch network comprises two MOSFETs or two other active semiconductor switches with two parallel-connected diodes, wherein said voltage-clamp network comprises one of the five sub-circuits: a diode series-connected with a resister-capacitor-diode sub-circuit, a diode series-connected with a MOSFET-capacitor sub-circuit, a resister-capacitor-diode sub-circuit series-connected with a MOSFET-capacitor sub-circuit, two series-connected resister-capacitor-diode sub-circuits, or two series-connected MOSFET-capacitor sub-circuits.

5. The circuit as claimed in claim 4, a center node between two said series-connected MOSFETs or two other active semiconductor switches with two parallel-connected diodes within said switch network and a center node between two sub-circuits within said voltage-clamp network are connected together.

6. A circuit to convert a DC voltage received at a DC input to an AC voltage, the circuit comprising:
an input inductor inserted between said DC input and first and second series circuits, wherein
said first series circuit connected in parallel with said second series circuit, said first series circuit comprises a switch network and first and second transformer primaries, and
said second series circuit comprises a voltage-clamp network and third and fourth transformer primaries;
a first capacitor is connected between a first node within said first series circuit and a second node within said second series circuit, wherein said first node is between said first transformer primary and said switch network, and wherein said second node is between said voltage-clamp network and said fourth transformer primary;
a second capacitor is connected between a third node within said first series circuit and a fourth node within said second series circuit, wherein said third node is between said switch network and said second transformer primary, and wherein said fourth node is between said voltage-clamp network and said third transformer primary; and
at least one of said transformer having two or more primary windings and at least one secondary winding are magnetically coupled to each other and providing said AC voltage.

7. The circuit as claimed in claim 6, wherein said input inductor is a parasitic inductor or an external inductor, wherein said first transformer primary, said fourth transformer primary are magnetically coupled to at least one transformer secondary of first transformer core, wherein said second transformer primary, said third transformer primary are magnetically coupled to at least one transformer secondary of said second transformer core.

8. The circuit as claimed in claim 6, wherein said switch network comprises one MOSFET or one other active semiconductor switch with parallel-connected diode, wherein said voltage-clamp network comprises a resister-capacitor-diode sub-circuit, or a MOSFET-capacitor sub-circuit.

9. The circuit as claimed in claim 6, wherein said switch network comprises two MOSFETs or two other active semiconductor switches with two parallel-connected diodes, wherein said voltage-clamp network comprises one of the five sub-circuits: a diode series-connected with a resister-capacitor-diode sub-circuit, a diode series-connected with a MOSFET-capacitor sub-circuit, a resister-capacitor-diode sub-circuit series-connected with a MOSFET-capacitor sub-circuit, two series-connected resister-capacitor-diode sub-circuits, or two series-connected MOSFET-capacitor sub-circuits.

10. The circuit as claimed in claim 9, a center node between two said series-connected MOSFETs or two other active semiconductor switches with two parallel-connected diodes within said switch network and a center node between two sub-circuits within said voltage-clamp network are connected together.
